(19) United States
(12) Patent Application Publication
(10) Pub. No.: US 2011/0033717 A1
(43) Pub. Date: Feb. 10, 2011

(54) METHOD FOR BONDING CERAMIC MATERIALS

(75) Inventors: John Roger Peterson, Provo, UT (US); M. Robert Mock, Midway, UT (US)

Correspondence Address: SNELL & WILMER L.L.P. (Main), 400 EAST VAN BUREN, ONE ARIZONA CENTER, PHOENIX, AZ, 85004-2202, US

(73) Assignee: Caldera Engineering, LC, Provo, UT (US)

(21) Appl. No.: 12/538,706

(22) Filed: Aug. 10, 2009

(51) Int. Cl. B32B 15/04; B32B 18/00; B23K 31/02

(52) U.S. Cl. 428/450; 228/121

(57) ABSTRACT

Systems and methods for bonding ceramic materials are disclosed herein. In various embodiments, a process is provided comprising the steps of disposing a bonding material at least partially adjacent to a surface of a first silicon carbide component and at least partially adjacent to a surface of a second silicon carbide component, and bonding said first silicon carbide component to said second silicon carbide component by heating, wherein said bonding material comprises vanadium or titanium.

### FIELD OF INVENTION

The invention generally relates to the field of bonding ceramic materials.

### BACKGROUND OF THE INVENTION

Ceramic materials and ceramic composite materials are increasingly used in various industrial applications to benefit from their unique physical properties. For example, ceramic materials are particularly useful in high temperature and/or highly corrosive environments.

One useful ceramic material is silicon carbide (“SiC”). SiC products may be fabricated by a variety of methods and various forms may be obtained commercially. For example, pure direct sintered SiC may be obtained from a variety of commercial suppliers. Beneficial properties of SiC include wear and corrosion resistance, high hardness and the ability to retain original dimensions and strength under high stress and high temperature. SiC also features a low coefficient of thermal expansion (“CTE”) and high thermal conductivity, both of which provide resistance to thermal shock. Nevertheless, thermal shock is a recognized failure mode for SiC components and is more likely to occur in larger SiC components. As the strength of an SiC component does not decrease as temperature increases, and as SiC has no melting point and does not decompose until a very high temperature (e.g. 2800° C.), there is no mechanism to relieve internal stresses in fired (e.g. direct sintered) components. Accordingly, larger direct sintered SiC components may contain increased residual stresses, which may lead to increased susceptibility to damage, wear, fracture, or other failure. Further, larger direct sintered SiC components may contain a distribution of minute flaws. Although smaller SiC components may contain a substantially similar distribution of minute flaws, the aggregate number of minute flaws in larger direct sintered SiC components tends to be larger than the aggregate number of minute flaws in smaller direct sintered SiC components. Such flaws may lead to the development of cracks if they are subjected to high tensile loads. As one would expect, with a larger minute flaw, a lower stress amount is needed to initiate a crack. Larger direct sintered SiC components may have an increased number of flaws and an increased amount of residual stress. Accordingly, larger direct sintered SiC components may result in an increased probability of crack initiation as compared to smaller direct sintered SiC components.

Thus, it is difficult to achieve a larger direct sintered SiC component having reduced retained (or residual) stresses using conventional methods. Further, the increased firing time to fabricate large SiC components increases fabricating costs.

Broken or damaged SiC components are difficult to repair in a manner suitable to withstand intended operating environments. Currently, broken SiC components are typically replaced rather than repaired. Accordingly, there is a need for novel methods of bonding smaller SiC components together so that, for example, smaller SiC components may be made into larger components and broken or damaged SiC components may be repaired.

### SUMMARY OF THE INVENTION

Accordingly, systems and methods for bonding ceramic materials are disclosed herein. In various embodiments, a process is provided comprising the steps of disposing a bonding material at least partially adjacent to a surface of a first silicon carbide component and at least partially adjacent to a surface of a second silicon carbide component, and bonding said first silicon carbide component to said second silicon carbide component by heating, wherein said bonding material comprises vanadium.

Further, in various embodiments, an article of manufacture is provided, wherein the article of manufacture is produced by a process comprising disposing a bonding material at least partially adjacent to a surface of a first silicon carbide component and at least partially adjacent to a surface of a second silicon carbide component, bonding said first silicon carbide component to said second silicon carbide component by heating, wherein said bonding material comprises vanadium.

Still further, in various embodiments, a method is provided having the steps comprising disposing a bonding material at least partially adjacent to a surface of a first silicon carbide component and at least partially adjacent to a surface of a second silicon carbide component, and bonding said first silicon carbide component to said second silicon carbide component by heating, wherein said bonding material comprises titanium.

Still further, in various embodiments, a method of repairing a silicon carbide component is provided having the steps comprising disposing a bonding material at least partially adjacent to a surface of a first broken silicon carbide component and at least partially adjacent to a surface of a second broken silicon carbide component, bonding the first broken silicon carbide component to the second broken silicon carbide component by heating, wherein the bonding material comprises vanadium.

Still further, in various embodiments, a method of repairing a silicon carbide component is provided having the steps comprising the steps of disposing a bonding material at least partially adjacent to a surface of a first silicon carbide component and at least partially adjacent to a surface of a second silicon carbide component, and bonding said first silicon carbide component to said second silicon carbide component by heating, wherein said bonding material comprises at least one of a vanadium flattened wire, an expanded form of vanadium and a vanadium foam.

Further, in various embodiments, a segmented valve plug is provided, wherein the segmented valve plug is produced by a process comprising disposing a first bonding material at least partially adjacent to a first surface of a first silicon carbide component and at least partially adjacent to a first surface of a second silicon carbide component, disposing a second bonding material at least partially adjacent to a second surface of the second silicon carbide component and at least partially adjacent to a first surface of a third silicon carbide component, bonding said first silicon carbide component to said second silicon carbide component and said second silicon carbide component to said third silicon carbide component by heating, wherein said first bonding material comprises vanadium and wherein said second bonding material comprises vanadium.

Still further, in various embodiments, an angle valve having a top choke and bottom choke is provided, wherein the top choke and the bottom choke are bonded by a process comprising disposing a bonding material at least partially adjacent to a surface of the top choke and at least partially adjacent to a surface of a the bottom choke, bonding said top choke to said bottom choke component by heating, wherein said bonding material comprises vanadium.

Moreover, in various embodiments, an article of manufacture is provided comprising a SiC component having a minimum cross sectional dimension of at least about 6 inches and a residual tensile stress of less than 800 psi.

### BRIEF DESCRIPTION OF THE DRAWINGS

FIG. 1 illustrates two ceramic components and a bonding material;

FIG. 2 illustrates two SiC components and a bonding material comprising vanadium;

FIG. 3 illustrates two broken SiC components and a bonding material;

FIG. 4 illustrates two SiC components and a bonding material;

FIG. 5 illustrates two SiC components and a bonding material comprising titanium;

FIGS. 6A and 6B illustrate a segmented plug in accordance with an exemplary embodiment;

FIG. 7 illustrates a segmented plug in accordance with an exemplary embodiment; and

FIG. 8 illustrates an angle valve in accordance with an exemplary embodiment.

### DETAILED DESCRIPTION

The following description of various embodiments herein makes reference to the accompanying drawing figures, which show various embodiments by way of illustration and its best mode. While these exemplary embodiments are described in sufficient detail to enable those skilled in the art to practice the invention, it should be understood that other embodiments may be realized and that logical, chemical, and mechanical changes may be made without departing from the spirit and scope of the invention. Thus, the detailed description herein is presented for purposes of illustration only and not of limitation. For example, steps or functions recited in descriptions of any method, system, or process, may be executed in any order and are not limited to the order presented. Moreover, any of the steps or functions thereof may be outsourced to or performed by one or more third parties. Furthermore, any reference to singular includes plural embodiments, and any reference to more than one component may include a singular embodiment. Recitation of multiple embodiments having stated features is not intended to exclude other embodiments having additional features or other embodiments incorporating different combinations of the stated features. Also, any reference to attached, fixed, connected or the like may include permanent, removable, temporary, partial, full and/or any other possible attachment option. Additionally, any reference to without contact (or similar phrases) may also include reduced contact or minimal contact.

As described herein, a process for bonding ceramic materials is provided, in addition to articles of manufacture comprising bonded ceramic materials and ceramic materials having a minimum cross sectional dimension of at least about 6 inches and a residual tensile stress of less than 800 psi

Many conventional ceramic bonding techniques yield weak bonds that fail easily upon impact or exposure to corrosives or high temperatures. In various embodiments, processes for bonding ceramic materials provided herein are better able to withstand extreme environments, such as high temperatures, high pressures, and corrosive environments.

As used herein, the term ceramic refers to any ceramic material. In various embodiments, the ceramic material SiC is used. As used herein, SiC means any material comprised of or substantially comprised of SiC in any known or hereinafter discovered or developed form or structure. As used herein, an SiC component may be a piece or part comprising SiC of any size or shape. For example, an SiC component may be a portion of a valve, valve trim, pipe, brick, plate, or any discrete piece of SiC.

SiC is known to be found in over one hundred crystal orders. For example, SiC having an alpha crystal structure (“alpha SiC”) may be formed by heating above about 1500° C. SiC having a beta crystal structure (“beta SiC”) may be formed by heating below about 1500° C. The processes disclosed herein, in various embodiments, may be used in conjunction with either alpha SiC or beta SiC. SiC used in conjunction with various embodiments may be formed using various known techniques, including direct sintering. SiC components, including direct sintered SiC, may be obtained from various commercial sources in various forms, such as alpha SiC or beta SiC.

In various embodiments, a bonding material is used. A bonding material may be any material capable of bonding two or more ceramic surfaces together. For example, a bonding material may be used to bond two or more SiC components. Bonding materials may take various forms, such as a foil, powder, a thin deposited layer by formed by chemical vapor deposition (such as would be applied during a chemical vapor deposit), physical vapor deposition, sputtering, magnetron, or other methods of applying a thin layer. Bonding materials may comprise one or more metals. For example, a bonding material may comprise one or more layers of metal foil. In embodiments having two or more layers of metal foil, each metal foil may be arranged so that a surface of one foil is at least partially in contact with a surface of another foil. In embodiments having two or more layers of metal foil, each metal foil may comprise one or more different metals. In accordance with various embodiments, metal foils may be selected from a group comprising vanadium, titanium, and/or the like.

Various bonding materials may be used in conjunction with various embodiments. For example, bonding materials may comprise vanadium. Bonding materials may comprise one or more forms of vanadium, including pure or substantially pure vanadium, alloys of vanadium, or compounds of vanadium. For example, V4Cr4Ti alloy may be used as a bonding material. In addition, many metals adjacent to or near vanadium on the periodic table may be used as bonding materials. For example, the metals Zr, Nb, Ti, Hf, Cr, Mo, Ta or W may be useful in a bonding material. While not wishing to be bound by theory, it is believed that these metals form adherent oxides that tend to resist chemical attack and, accordingly, may be acceptable for use in corrosion environments. It is believed that vanadium does not form a self protecting oxide. Further, vanadium exhibits corrosion resistance to acids and bases, although vanadium may be susceptible to corrosion due to nitric acid. Titanium shares many of the beneficial properties of vanadium.

In various embodiments, vanadium foil may be used as a bonding material. Vanadium foil may be comprised of pure or substantially pure vanadium. Vanadium foil may be prepared or purchased commercially. Vanadium foil may be of thickness of from about 0.1 mil (0.0025 mm) to about 10 mil (0.127 mm). Vanadium is a very ductile material when pure and may be easily fabricated into foil forms. Vanadium foil may be obtained in a wide variety of thicknesses. Vanadium foil may be purchased at ESPI, 1050 Benson Way, Ashland, Oreg. 97520 or from Fine Metals, 15117 Washington Way, Ashland, Va. In various embodiments, bonding material comprising vanadium foil may be of thickness of from about 0.1 mil to about 10 mil, of from about 0.5 mil to about 5 mil, and of from about 1 mil to about 2 mil.

In various embodiments, vanadium powder may be used as a bonding material. In various embodiments, vanadium powder may be of from about −600 mesh to about −50 mesh, of from about −400 mesh to about −150, and of from about −325 mesh to about −300. Vanadium powder may be obtained from ESPI, 1050 Benson Way, Ashland, Oreg., 97520. In various embodiments, powder or another form of vanadium may be deposited by dusting, evaporation, sublimation, sputtering or chemical vapor deposition. For example, vanadium powder may be deposited by dusting with a brush.

In various embodiments, titanium foil may be used as a bonding material. Titanium foil may be prepared or purchased commercially. Titanium foil may be of thickness of from about 0.1 mil to about 10 mil, of from about 0.5 mil to about 5 mil, and of from about 1 mil to about 2 mil. Titanium foil may be obtained from several sources such as Fine Metals, 15117 Washington Highway, Ashland, Va., 23005.

In various embodiments, titanium powder may be used as a bonding material. The titanium powder may be of from about −600 mesh to about −50 mesh, of from about −400 mesh to about −150, and of from about −325 mesh to about −300.

In various embodiments, powder or another form of titanium may be deposited by dusting, evaporation, sublimation, sputtering or chemical vapor deposition. For example, titanium powder may be deposited by dusting with a brush.

In various embodiments, a bonding material comprises vanadium foil layered with one or more metal foils that comprise a different metal. In such embodiments, a bonding material may comprise a first layer of vanadium foil, a layer of another metal foil, and a second layer of vanadium foil. The metal foil layer between the first and second layers of vanadium foil may comprise Zr, Nb, Ta, Ti, Hf, Cr, Mo or W, among other suitable metals. For example, a bonding material may comprise a first layer of vanadium foil, a layer of zirconium metal foil, and a second layer of vanadium foil. In such embodiments, zirconium foil may be of thickness of from about 0.1 mil to about 10 mil, of from about 0.5 mil to about 5 mil, and of from about 1 mil to about 2 mil. Zirconium foil may be obtained from Fine Metals, 15117 Washington Highway, Ashland, Va. 23005. Also for example, a bonding material may comprise a first layer of vanadium foil, a layer of titanium metal foil, and a second layer of vanadium foil. In such embodiments, titanium foil may be of thickness of from about 0.1 mil to about 10 mil, of from about 0.5 mil to about 5 mil, and of from about 1 mil to about 2 mil. Zirconium foil can be obtained from Fine Metals, 15117 Washington Highway, Ashland, Va. 23005. In further embodiments, a bonding material may comprise a first layer of titanium foil, a layer of zirconium foil, and a second layer of titanium foil. In various embodiments having a bonding material that comprises one or more layers of metal foil, each metal foil may be arranged so that a surface of one foil is at least partially in contact with a surface of another foil.

A bonding material may be used in the bonding of a first SiC component and a second SiC component. Each of the first SiC component and the second SiC component comprises a bonding surface. A bonding surface may comprise any surface of an SiC component where bonding is desired. A bonding surface may have a variety of roughness, ranging from smooth and substantially smooth, rough and substantially rough. In various embodiments, it may be advantageous to grind, sand, or otherwise smooth or flatten one or more of the bonding surfaces, although there are applications where relatively rough bonding surfaces are advantageous. It is believed that bonding comprises a solid state diffusion and/or chemical reaction, so therefore, in various embodiments, more smooth surfaces may be advantageous. For example, in various embodiments, surfaces may be of a flatness of about 8. In various embodiments, surface finishes may be from about 2 (0.05 microns Ra) to about 63 (1.6 microns Ra) and from about 16 (0.4 microns Ra) to about 4 (0.1 microns Ra). For surface finishes outside such ranges, it may be advantageous to utilize bonding materials such as expanded metals, metal foams and/or flattened wires or flattened strips of bonding material. For example, in such embodiments, vanadium or titanium in an expanded form, foam form, or flattened wire or strip form may be used as a bonding material. Further, in various embodiments, a wire rolled to a flat cross section and then disposed in an appropriate pattern to allow bonding may be used.

In various embodiments, bonding material comprising metal foil may have a flatness of less than +/−0.0003″ (7.5 microns), although flatness may range from about 0.1 microns to about 1000 microns.

As described above, in various embodiments, in preparation for bonding, a bonding material may be disposed between one or more ceramic components. For purposes of illustration only, various embodiments described herein refer to bonding a first SiC component and a second SiC component, although other ceramic materials may be used and multiple components may undergo bonding at once. Further, one or more types of ceramic materials may be bonded together. For example, an SiC component may be bonded to a component that comprises a different ceramic material. When a bonding material is suitably disposed between a first ceramic component and a second ceramic component, all three elements together may be referred to as a pre-bonded component. For example, a pre-bonded component may comprise a first SiC component, a second SiC component, and a bonding material.

In embodiments using one or more foil layers as a bonding material, the one or more foil layers may be disposed between the bonding surfaces of each ceramic component. In various embodiments, bonding material may be deposited by chemical vapor deposition, physical vapor deposition or any other deposition method such as electrodeposition. Physical vapor deposition, as used herein, comprises all vapor deposition mechanisms that may include techniques such as e-beam evaporation, sputtering, reactive evaporation, sublimation, or any of the many similar arts that result in the deposition of a metal or material on a substrate. In embodiments having a powdered bonding material, bonding material may be disposed by any suitable method for depositing powder. In accordance with various embodiments, the disposing of bonding material between the first SiC component and the second SiC component may occur on only the first bonding surface, with the corresponding second bonding surface being placed at least partially in contact with the first bonding surface after the deposition of the bonding material. For example, a first SiC component may have a bonding material deposited onto a first bonding surface and then a bonding surface of a second SiC component may be brought into at least partial contact with the first bonding surface. In accordance with various embodiments, the disposing of bonding material between the first SiC component and the second SiC component may occur on both the first bonding surface and the second bonding surface. In such embodiments, the two corresponding bonding surfaces may be placed at least partially in contact with each other after the deposition of the bonding material. For example, a first SiC component may have a bonding material deposited onto a first bonding surface and a second SiC component may have a bonding material deposited onto a second bonding surface. In such an example, the second bonding surface may be brought into at least partial contact with the first bonding surface.

In various embodiments, bonding is used to bond one or more ceramic components together. For example, in various embodiments, bonding is used to bond one or more SiC components together. A pre-bonded component that has undergone bonding may be referred to as a bonded component. For example, one or more SiC components and a bonding material may be organized into a pre-bonded component, undergo bonding, and result in a bonded component. Bonding comprises heating a pre-bonded component and the optional addition of pressure on the pre-bonded component in a direction normal to or substantially normal to the bonded surface. Heating may be accomplished by raising the ambient temperature of the environment of the pre-bonded component. Heating may be performed in any suitable manner, for example in a furnace or other vessel. Bonding may occur at from about 900° C. to about 1300° C. In various embodiments, bonding occurs from about 1100° C. to about 1200° C.

Bonding hold times refer to the amount of time a pre-bonded component is exposed to a given temperature during bonding. Bonding hold times may range from about 1 minute to about 120 minutes, and in various embodiments bonding hold times may range from about 2 minutes to about 120 minutes. For example, in embodiments where bonding occurs at 1100° C., bonding hold times from about 5 minutes to about 45 minutes may be used and, in various embodiments, a bonding hold time of 30 minutes is used. Also for example, in embodiments where bonding occurs at 1200° C., bonding hold times from about 2 minutes to about 30 minutes may be used and, in various embodiments, a bonding hold time of 10 minutes is used. Using excessive bonding temperatures and/or excessive hold times may render the resulting bond brittle. While not wishing to be bound by theory, it is believed that excessive bonding temperatures and/or excessive hold times lead to the formation of intermetallics through the bond itself. While not wishing to be bound by theory, it is believed that bonding may be better accomplished using a bonding temperature and hold time combination, as disclosed herein, that do not lead to the formation of intermetallics through the bond. It is theorized that using a bonding temperature and hold time combination as disclosed herein maintains a portion of the bonding material (for example, the center of the bonding material) in metallic form and not as an intermetallic. Therefore, in various embodiments, the bonding hold time and/or temperature are selected to achieve at least partial intermetallic formation at the interface between a bonding surface and a bonding material but to minimize the formation of intermetallics that transect the bonding material.

Bonding may be conducted in a vacuum or under a protective atmosphere. For example, any inert gas (e.g. He and/or Ar) may be used.

In various embodiments, bonding may further optionally comprise the addition of pressure on the pre-bonded component in a direction normal to or substantially normal to the bonding surface. The pressure may be achieved in any suitable manner, and may include the exertion of pressure on the first ceramic component, the second ceramic component, or both ceramic components. Pressure may be exerted using weights (e.g. deadweight), a clamp, a vise, a screw press, or any other device or apparatus suitable for applying pressure and withstanding bonding temperatures. For example, in various embodiments, a weight is placed on one of the ceramic components such that the pull of gravity exerts pressure in a direction normal to or substantially normal to the bonding surface. Any type of weight may be used for this purpose, although it is advantageous to use weights that withstand bonding temperatures and/or that do not detrimentally react with the SiC. In various embodiments, pressures from about 1 lbs/in² (psi) to about 100 psi are used. For example, in various embodiments, pressures of above about 4 psi are used and in other embodiments, a pressure of about 4 psi is used.

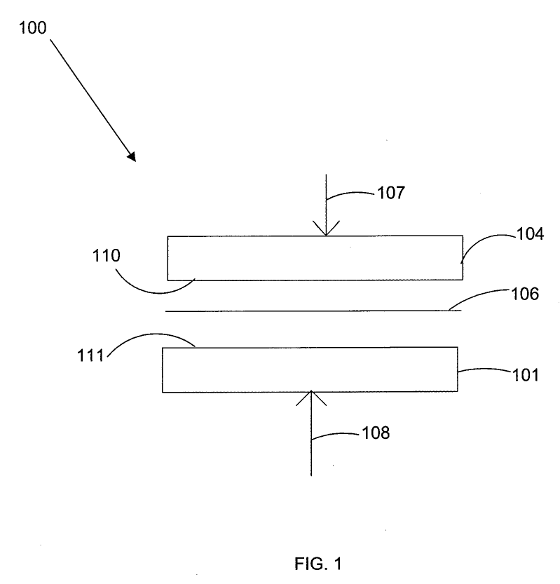

With reference to FIG. 1, pre-bonded component 100 is illustrated. First ceramic component 104 has bonding surface 110 and second ceramic component 101 has bonding surface 111. Bonding material 106 is disposed between first ceramic component 104 and second ceramic component 101. Pre-bonded component 100 undergoes bonding under pressure 107 and optional pressure 108. As described above, pressure 107 and optional pressure 108 may be provided by, for example, a vise or clamp. Pressure 107 may be provided by a weight. Pre-bonded component 100 undergoes bonding at any of the bonding temperatures or hold times described above.

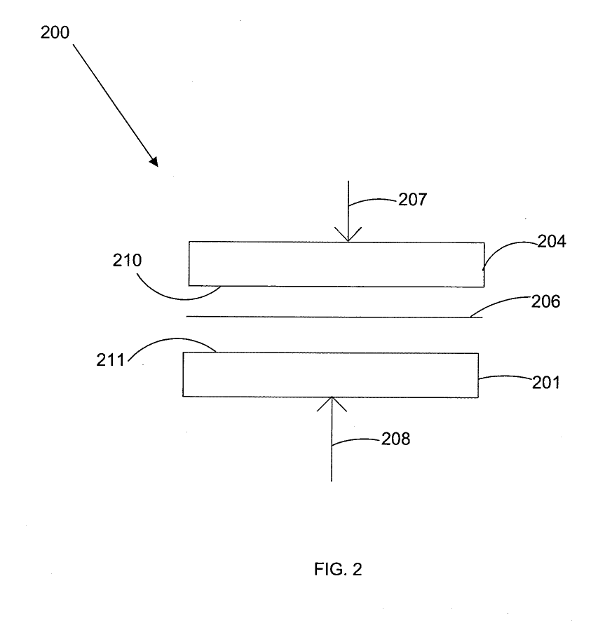

With reference to FIG. 2, pre-bonded component 200 is illustrated. First SiC component 204 has bonding surface 210 and second SiC component 201 has bonding surface 211. Vanadium foil 206 is disposed between first SiC component 204 and second SiC component 201. Pre-bonded component 200 undergoes bonding under pressure 207 and optional pressure 208. As described above, pressure 207 and optional pressure 208 may be provided by, for example, a vise or clamp. Pressure 207 may be provided by a weight. Pre-bonded component 200 undergoes bonding at any of the bonding temperatures or hold times described above.

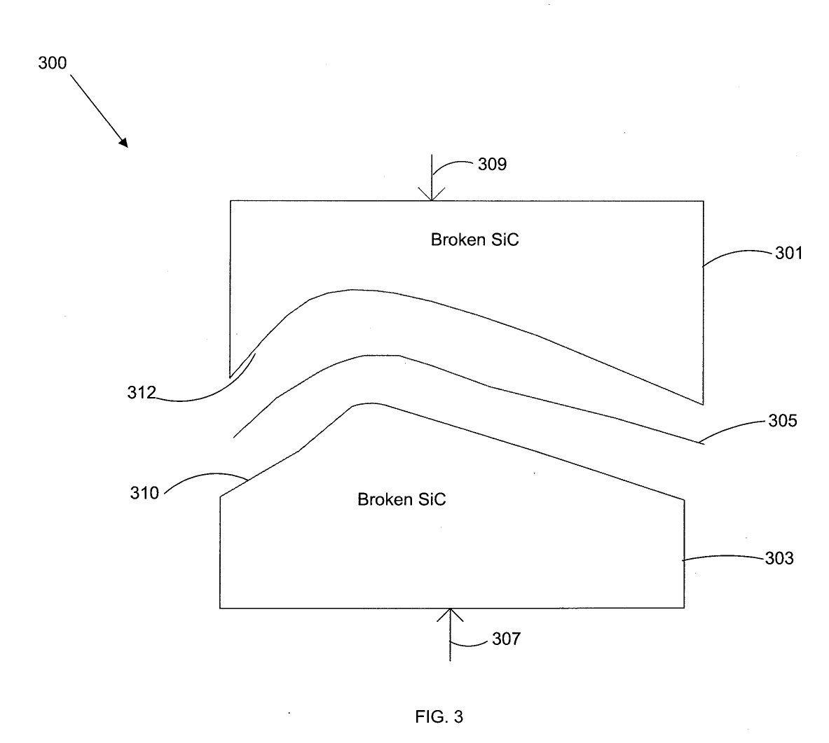

FIG. 3 illustrates an embodiment having two broken SiC components assembled as a pre-bonded component. Such an embodiment is consistent with various SiC repair activities. With reference to FIG. 3, pre-bonded component 300 is illustrated. First broken SiC component 301 has bonding surface 312 and second broken SiC component 303 has bonding surface 310. Vanadium powder 305 is disposed between first broken SiC component 301 and second broken SiC component 303. Pre-bonded component 300 undergoes bonding under pressure 309 and optional pressure 307. As described above, pressure 309 and optional pressure 307 may be provided by, for example, a vise or clamp. Pressure 309 may be provided by a weight. Pre-bonded component 300 undergoes bonding at any of the bonding temperatures or hold times described above.

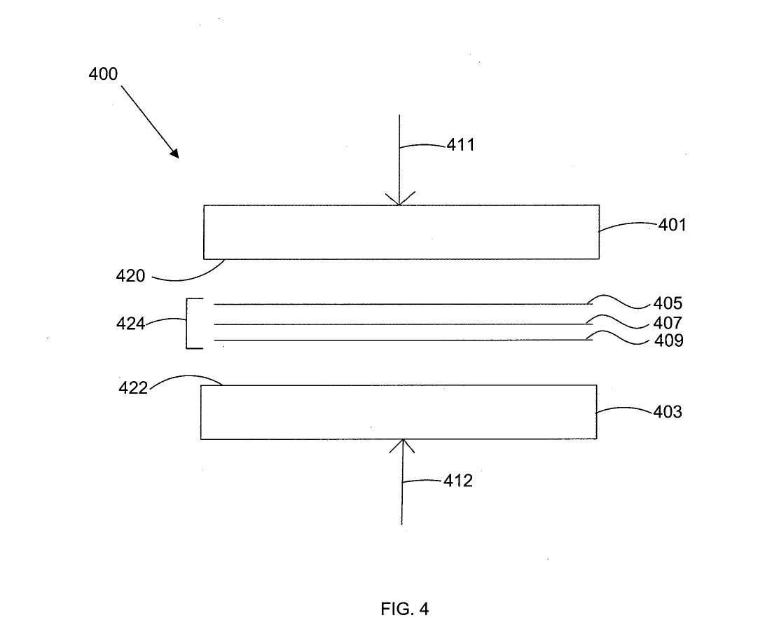

With reference to FIG. 4, pre-bonded component 400 is illustrated. First SiC component 401 has bonding surface 420 and second SiC component 403 has bonding surface 422. Bonding material 424 comprises first vanadium foil 405, zirconium foil 407, and second vanadium foil 409. Bonding material 424 is disposed between first SiC component 401 and second SiC component 403. Pre-bonded component 400 undergoes bonding under pressure 411 and optional pressure 412. As described above, pressure 411 and optional pressure 412 may be provided by, for example, a vise or clamp. Pressure 411 may be provided by a weight. Pre-bonded component 400 undergoes bonding at any of the bonding temperatures or hold times described above.

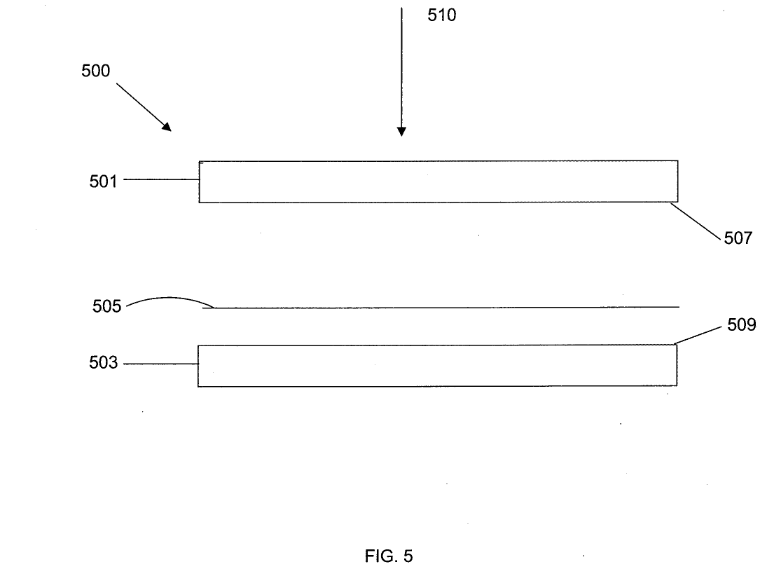

With reference to FIG. 5, pre-bonded component 500 is illustrated. First SiC component 501 has bonding surface 507 and second SiC component 503 has bonding surface 509. Titanium foil 505 is disposed between first SiC component 501 and second SiC component 503. Pre-bonded component 500 undergoes bonding under pressure 510. Pressure 510 may be provided by a weight. Pre-bonded component 500 undergoes bonding at any of the bonding temperatures or hold times described above.

As a further example, a film of vanadium foil of 0.001 inch thickness is disposed between a first direct sintered SiC component, having dimensions 2 inch×2 inch×0.375 inch, and a second direct sintered SiC component of the same dimensions to form a pre-bonded component. The pre-bonded component is placed in a furnace, heated to 1100° C., and held for 10 minutes in a vacuum of 5×10⁻⁴ Torr to form a bonded component. The bonded component is destructively tested by holding the bonded component in two brackets and applying a torque to the bond line. The test specimens fracture at loads between 100 in-lbs and 300 in-lbs. The fracture line reveals that the bond is still intact, indicating that the SiC material fractured before the bond.

Moreover, in various embodiments, smaller ceramic components may be bonded to form larger ceramic components, which may result in lowered internal stresses and increased resistance to failure. For example, SiC may be a ceramic component selected for use with these various embodiments.

Direct sintered SiC components may be obtained from a variety of commercial sources. The quality of commercially available direct sintered SiC components varies, with certain vendors providing direct sintered SiC components of very high quality whereas other vendors produce average or lower quality direct sintered SiC components. However, there is an opportunity to improve components made from even the highest quality commercially available SiC components using the methods and techniques described herein. As discussed, during direct sintering of SiC, internal stresses in the final component may be formed. Typically, the larger the component formed, the greater the internal stresses. In various other direct sintered ceramic materials, the sintering process itself or a post-sintering annealing process may be used to relieve internal stresses. However, given that SiC does not soften at high temperatures and that SiC does not melt but instead decomposes at extremely high temperatures (e.g. about 2800° C.), there is no analogous method of relieving internal stresses in larger SiC components.

Stresses in ceramic materials may be additive and may become centered or focused on a microscopic void or flaw in the material. Residual stresses may be raised higher with outside applied stresses. For example, the sum of external and internal stresses could cause failure from inside a ceramic component. In many cases, the point of failure is located at an internal flaw rather than at the point of applied stress. Even when an applied stress appears to be compressive in nature, there may be tensile stresses developed elsewhere in the ceramic component. Small internal cracks may form in the ceramic material and may lead to later catastrophic or complete failure when other stresses are applied. Stress may be applied thermally or physically. It is further understood that there may be a natural distribution of microscopic voids or flaws in SiC components that may be characterized by a Weibull probability distribution. Accordingly, larger SiC components may be prone to failure due to the internal stresses.

Further, it is believed that bonds, as described herein, may act as crack stoppers or arrestors. It is believed that when a crack initiates in a brittle material, such as a ceramic component, the crack tends to propagate until it reaches an exterior surface. It is further believed that bonded surfaces provide a level of resistance to crack propagation, thereby slowing or stopping a crack from becoming larger. For example, a crack may initiate in a SiC component and propagate to a bonding surface. There may not be sufficient forces available for the crack to penetrate the bonding surface and propagate through the bond. Thus, in various embodiments, a bonded surface provides resistance to crack propagation.

In accordance with an exemplary embodiment, a larger SiC component is assembled from one or more smaller SiC components formed via conventional means, such as direct sintering, using techniques described herein. The resultant larger SiC component achieves a reduction of internal stresses as compared to a large, monolithic SiC component of comparable size that was formed via conventional means such as, for example, direct sintering.

In various embodiments, an article of manufacture is provided comprising a SiC component having a minimum cross sectional dimension of at least about 6 inches and a residual tensile stress of less than about half the residual tensile stress of a direct sintered SiC component having a minimum cross sectional dimension of at least about 6 inches, and in various embodiments, an article of manufacture is provided comprising a SiC component having a minimum cross sectional dimension of at least about 6 inches and a residual tensile stress of less than about an eighth of the residual tensile stress of a direct sintered SiC component having a minimum cross sectional dimension of at least about 6 inches.

In various embodiments, an article of manufacture is provided comprising a SiC component having a minimum cross sectional dimension of at least about 6 inches and a residual tensile stress of less than 800 psi, and in various embodiments, a SiC component having a minimum cross sectional dimension of at least about 6 inches and a residual tensile stress of less than 500 psi. A direct sintered SiC component having those dimensions would likely have a residual stress of at least about 4000 psi or more. Residual stress may be measured by subjecting a component to fracture and examining the resultant pieces. Any acceptable method of fractography and/or fracture mechanics may be used to determine the residual stresses.

For example, a first SiC component having a cross sectional dimension of at least 2 inches and a bonding surface, a second SiC component having a cross sectional dimension of at least 2 inches and a bonding surface, and a third SiC component having a cross sectional dimension of at least 2 inches and a bonding surface may have a first bonding material disposed between the first SiC component and the second SiC component and a second bonding material disposed between the first SiC component and the second SiC component. The resultant pre-bonded component may undergo bonding under conditions as described herein. The resulting bonded component may have a residual tensile stress of less than 800 psi.

As described herein, there is a need for making SiC products with longer useful life. Useful life may comprise a longer time in service or an increased number of usages or a more predictable time in service. Accordingly, in accordance with various embodiments, the product life of a larger SiC components formed by the bonding techniques described herein, (for example, vanadium or titanium bonded SiC products) may be longer than the product life of similar size monolithic SiC components or similar size SiC components made using conventional techniques such as direct sintering. Thus, in various embodiments, predictable product life facilitates use of regularly scheduled maintenance and regularly scheduled maintenance may be more effectively employed and early part failure may be reduced as compared to conventional means. This may be due to the reduction of internal stresses, the provided resistance to crack propagation, and/or due to other reasons. Moreover, when SiC components fail, the bonding techniques as described herein may be used to restore and/or repair the component without the need for full component replacement.

In various embodiments, bonded components may be used to form valves, valve trim, and pipes. For example, in various embodiments, a segmented plug may be formed using the bonding methods disclosed herein, resulting in reduced stresses in the plug head. The head may be assembled with a bolt through the center and may be bonded along the segments. In various embodiments, bonded components may be used to form furnace walls, furniture, and various other components. Further, the various processes described herein may be useful for the repair of the same.

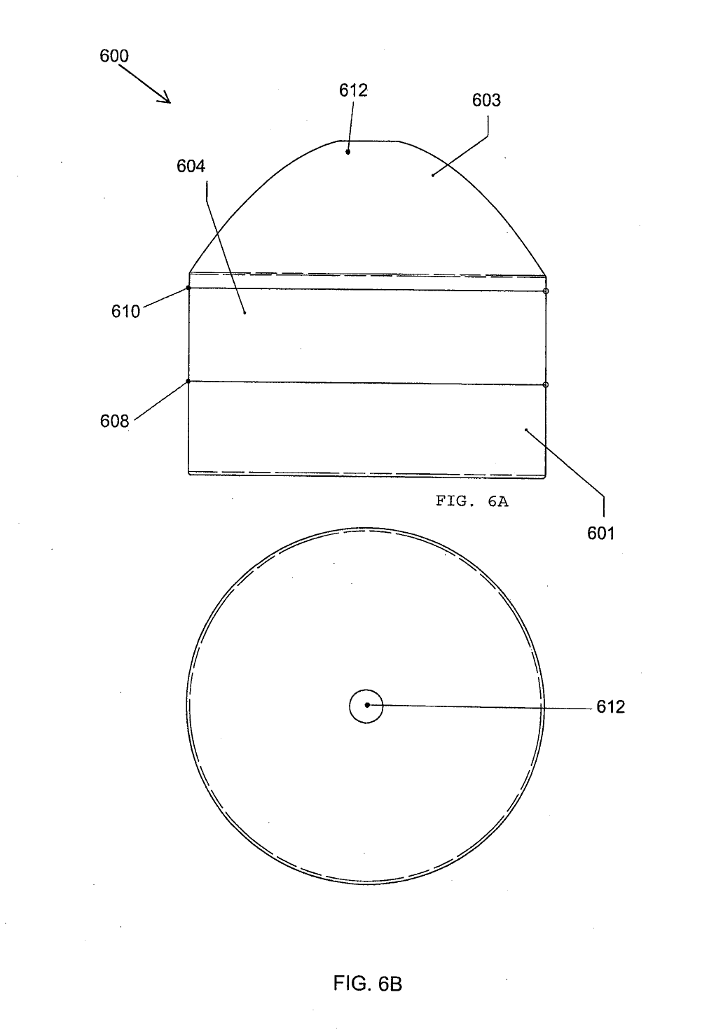

With reference to FIG. 6A, segmented plug 600 is illustrated. Segmented plug 600 is formed by bonding subcomponents 601, 603, and 604 using any of the bonding methods herein described. For example, subcomponents 601, 603, and 604 may be formed by conventional means, such as direct sintering. Bonding material 608 may be arranged to so that it is adjacent to a bonding surface of subcomponent 601 and a bonding surface of subcomponent 604. Bonding material 610 may be arranged to so that it is adjacent to a bonding surface of subcomponent 603 and a bonding surface of subcomponent 604. The resultant pre-bonded component may undergo bonding under conditions as described herein. In various embodiments, segmented plug 600 has aperture 612, also shown in FIG. 6B.

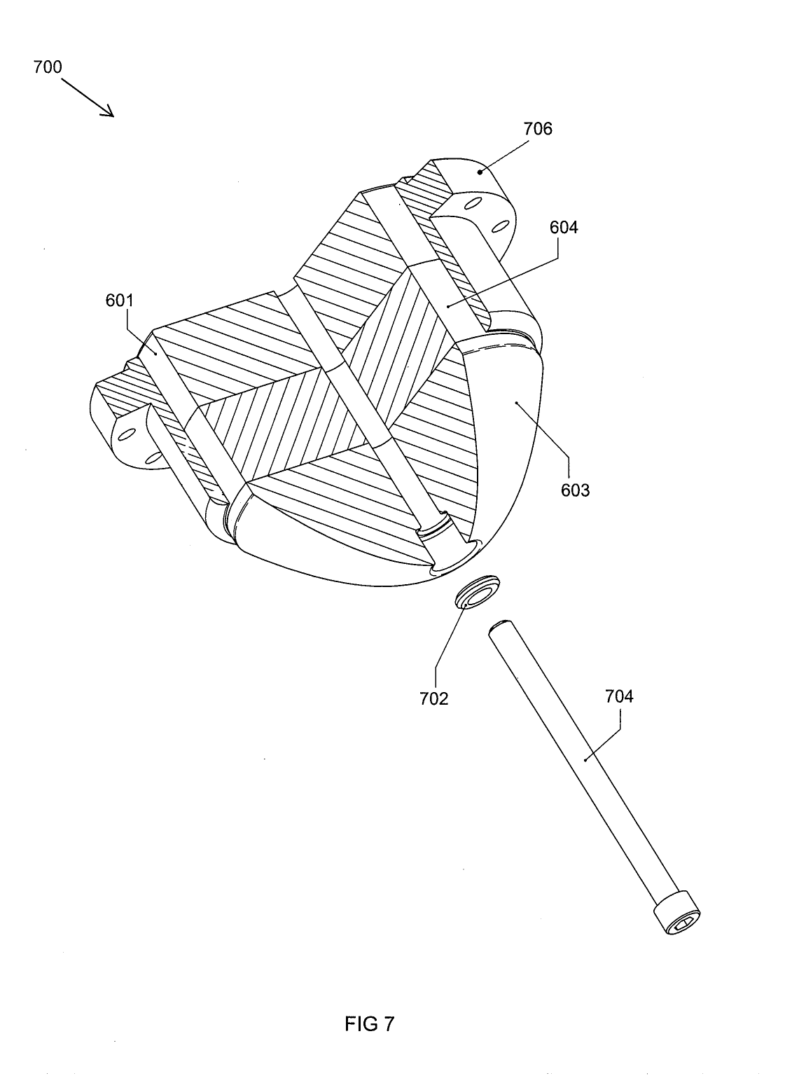

With reference to FIG. 7, segmented plug assembly 700 is illustrated. Segmented plug 700 comprises segmented plug 600 with various additional components. Collar 706 is shown around a portion of segmented plug 601. Tube 704 is shown apart from segmented plug 601. Ring 702 may fit around tube 704 when tube 704 is inserted into segmented plug 601.

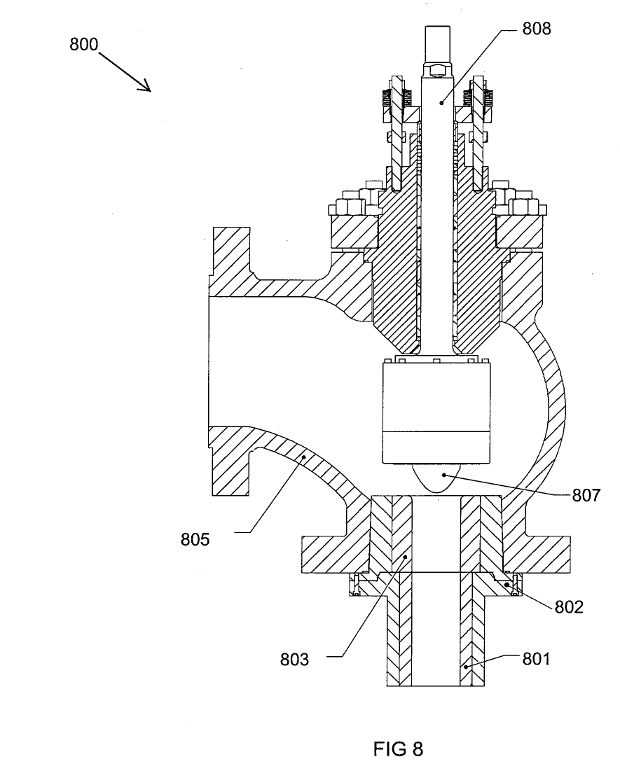

With reference to FIG. 8, a cross section of angle valve 800 is shown. Angle valve 800 comprises stem 808, plug 807, valve body 805, top choke 803 and bottom choke 801. One or more of stem 808, valve body 805, top choke 803 and bottom choke 801 may comprise SiC. Although top choke 803 and bottom choke 801 may not be bonded together, in various embodiments, top choke 803 and bottom choke 801 are bonded together using the methods described herein to form a bonded choke (not shown). Further, top choke 803 and/or bottom choke 801 may comprise SiC that has undergone bonding as described herein.

Further, it has been found that the reaction of nickel or copper with the SiC components may form eutectic fluids well below the melting point of either silicon, copper or nickel. For example, at above about 965° C., SiC may be put in contact with nickel to form a nickel silicide. Copper may form a eutectic with the silicon at 802° C. and above. While the formation of nickel silicide is not preferred in the bonding techniques set forth herein, such formation of nickel silicide may be an economical alternative to conventional techniques especially where a pure nickel silicide is desirable such as in forming very pure alloys.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
disposing a bonding material at least partially adjacent to a surface of a first silicon carbide component and at least partially adjacent to a surface of a second silicon carbide component;
bonding said first silicon carbide component to said second silicon carbide component by heating; and
wherein said bonding material comprises vanadium.

2. The method of claim 1, wherein said bonding material further comprises a first vanadium foil.

3. The method of claim 1, wherein said bonding material further comprises at least one of vanadium powder and vanadium applied by chemical vapor deposition.

4. The method of claim 2, wherein said bonding material further comprises a metal foil at least partially adjacent to said first vanadium foil and a second vanadium foil at least partially adjacent to said metal foil.

5. The method of claim 1, wherein said heating comprises heating from about 900° C. to about 1300° C.

6. The method of claim 1, wherein said heating occurs from about 2 minutes to about 120 minutes.

7. The method of claim 1, further comprising exerting a pressure in a direction normal to at least one of said surface of said first silicon carbide component and said surface of said second silicon carbide component.

8. The method of claim 7, wherein said pressure is from about 1 psi to about 100 psi.

9. The method of claim 4, wherein said metal foil comprises a metal selected from the group consisting of Zr, Nb, Ta, Ti, Hf, Cr, Mo or W.

10. An article of manufacture produced by a process comprising:
disposing a bonding material at least partially adjacent to a surface of a first silicon carbide component and at least partially adjacent to a surface of a second silicon carbide component;
bonding said first silicon carbide component to said second silicon carbide component by heating; and
wherein said bonding material comprises vanadium.

11. The article of claim 10, wherein said bonding material further comprises a first vanadium foil.

12. The article of claim 10, wherein said bonding material further comprises at least one of vanadium powder and vanadium applied by chemical vapor deposition.

13. The article of claim 10, wherein said bonding material further comprises a metal foil at least partially adjacent to said first vanadium foil and a second vanadium foil at least partially adjacent to said metal foil.

14. The article of claim 13, wherein said metal foil comprises a metal selected from the group consisting of Zr, Nb, Ta, Ti, Hf, Cr, Mo or W.

15. The article of claim 10, wherein said heating comprises heating from about 900° C. to about 1300° C.

16. The article of claim 10, wherein said heating occurs from about 2 minutes to about 120 minutes.

17. The article of claim 10, further comprising exerting a pressure in a direction normal to at least one of said surface of said first silicon carbide component and said surface of said second silicon carbide component.

18. The article of claim 17, wherein said pressure is from about 1 psi to about 10 psi.

19. A method comprising:
disposing a bonding material at least partially adjacent to a surface of a first silicon carbide component and at least partially adjacent to a surface of a second silicon carbide component; and
bonding said first silicon carbide component to said second silicon carbide component by heating,
wherein said bonding material comprises titanium.

20. The method of claim 19, wherein said bonding material further comprises a first titanium foil, a metal foil, and a second titanium foil, wherein said metal foil comprises a metal selected from the group consisting of Zr, Nb, Ti, Hf, V, Ta, Cr, Mo or W.

21. The method of claim 19, wherein said heating comprises heating from about 900° C. to about 1300° C. and said heating occurs from about 2 minutes to about 120 minutes.
